(19) United States
(12) Patent Application Publication
(10) Pub. No.: US 2004/0264213 A1
(43) Pub. Date: Dec. 30, 2004

(54) Fiber optic display

(76) Inventor: Max Davis, Sarasota, FL (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/880,877

(22) Filed: Jun. 30, 2004

Related U.S. Application Data
(60) Provisional application No. 60/483,857, filed on Jun. 30, 2003.

(51) Int. Cl. F21S 4/00

(52) U.S. Cl. 362/565

(57) ABSTRACT

The present invention provides an apparatus for the fiber optic illumination of a flexible planar member to form an ornamental display item. The flexible planar member may be provided in many forms such that various ornamental displays are realized. The flexible planar member may be provided as fabric or other materials such as cardboard, fiberglass, and polymers. The fiber optic cables included in the apparatus are selectable to operate in one of several flashing modes to provide an amusing ornamental display.

### RELATED APPLICATIONS

The present invention claims the benefit of U.S. Provisional Application Ser. No.: 60/483,857 filed Jun. 30, 2003.

### FIELD OF THE INVENTION

The present invention relates to fiber optic displays and more particularly to flashing fiber optic displays disposed on a flexible planar member.

### BACKGROUND OF THE INVENTION

Fiber optic displays are a superior alternative to existing forms of illuminated displays with great graphic capabilities, long life, and maintenance free operation. These sorts of displays are typically less costly to operate than neon, incandescent, and fluorescent displays. And, these types of displays exhibit not flickering or buzz noise and are typically not susceptible to, or cause, electronic interference. It is appreciated that many illuminated ornamental displays are very fragile and are designed using conventional light sources that require frequent maintenance and/or replacement. Thus, there exist a need for an illuminated ornamental display that can be operated at a lower cost and is more robust than conventional illuminated displays.

### SUMMARY OF THE INVENTION

The present invention provides an apparatus for the fiber optic illumination of an ornamental display that includes a flexible planar member for supporting a housing wherein the housing has a power source disposed therein. Additionally, a plurality of light emitting diodes (LEDs) is disposed on the flexible planar member that is placed in electrical communication with the power source.

The apparatus further includes a plurality of fiber optic cable bundles wherein one of each of the plurality of light emitting diodes is placed in optical communication with one of each of the fiber optic bundles at a first end. A second end of each of the fiber optic bundles is attached to flexible planar member to form an ornamental display such as a Christmas tree, a Christmas stocking, a teddy bear, a flower, and various other types of illuminated ornamental designs.

A programmable microprocessor is also disposed on the flexible planar member and placed in communication with the power source. The programmable microprocessor operates to selectively cause the light emitting diodes to be illuminated in one of a plurality of modes. The modes on illumination illustratively include continuous, periodic, intermittent, random, and multiple diodes illuminating simultaneously.

### BRIEF DESCRIPTION OF THE FIGURES

A better understanding of the present invention will be had upon reference to the following detailed description when read in conjunction with the accompanying drawings in which like parts are given like reference numerals and wherein:

FIG. 1 illustrates an ornamental display in the form a Christmas tree illuminated with the fiber optic display apparatus as according to the invention;

FIG. 2 illustrates an ornamental display in the form of a Christmas stocking illuminated with the fiber optic display as according to the invention; and

FIG. 3 illustrates a schematic diagram of the electronic circuit of the fiber optic display apparatus as according to the invention.

### DETAILED DESCRIPTION OF THE INVENTION

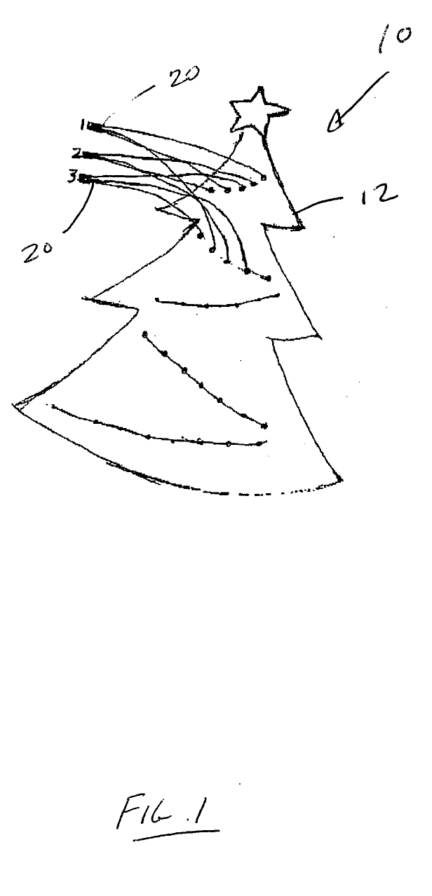

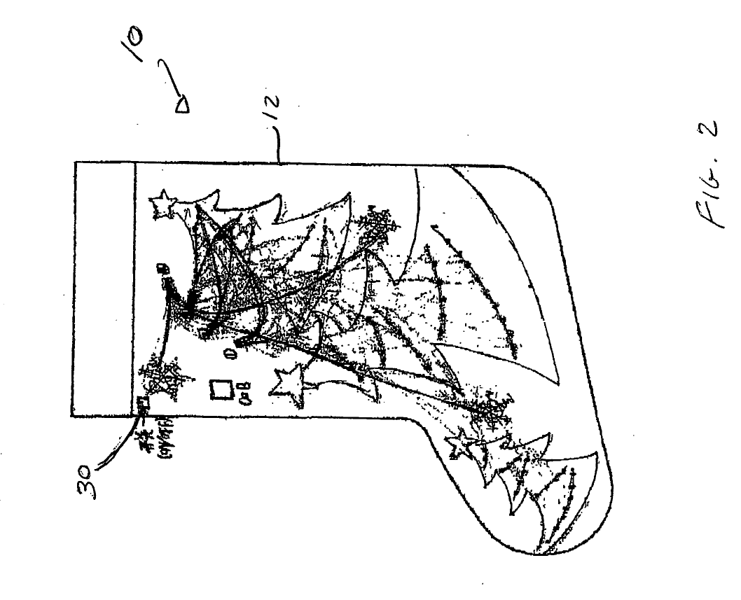

The present invention provides an apparatus 10 for the fiber optic illumination of a flexible planar member 12 to form an ornamental display item in a design such as a Christmas tree or Christmas stocking as illustrated in FIGS. 1 and 2. The flexible planar member 12 of the present invention may be provided in many forms such that various ornamental displays are realized. The flexible planar member 12 may be provided as fabric or other materials such as cardboard, fiberglass, and polymers. The fiber optic cables included in the apparatus 10 are selectable to operate in one of several flashing modes to provide an amusing ornamental display.

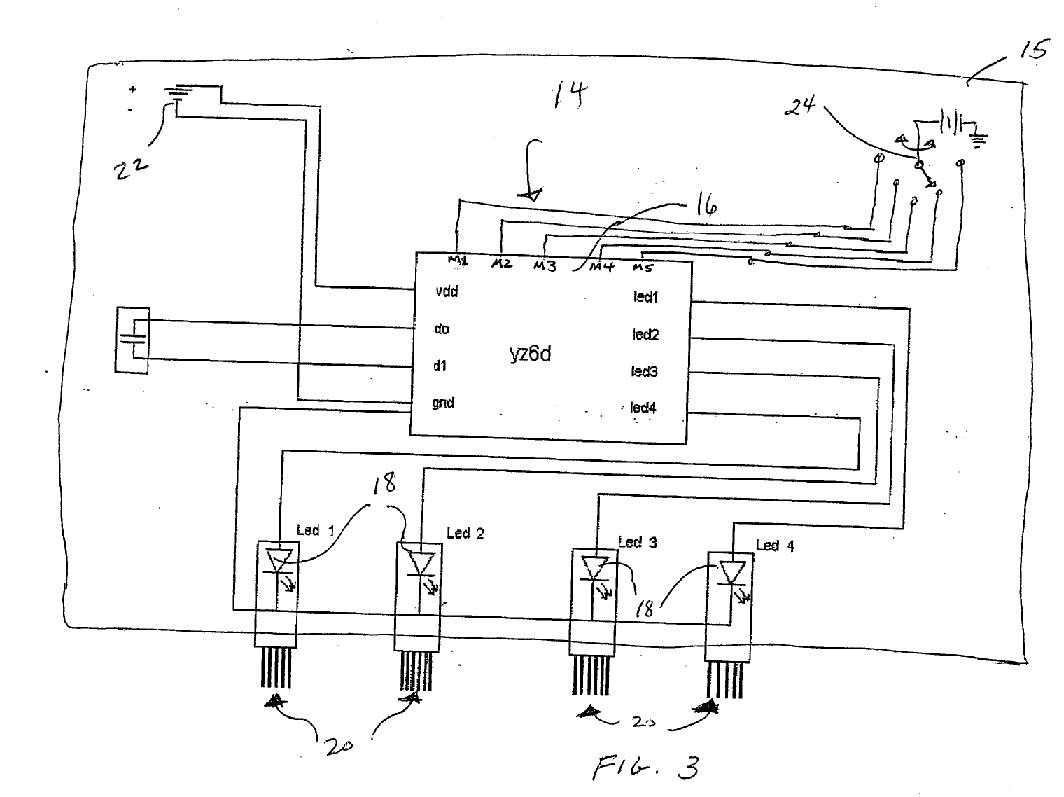

With reference to FIG. 3, the apparatus 10 comprises an electronic circuit 14 including a microprocessor 16 in communication with a plurality of light emitting diodes (LEDs) 18 wherein the LEDs 18 are each in communication with a discrete bundle of fiber optic cables 20. The electronic circuit 14 is preferably provided in a housing 15 supported on the flexible planar member 12. It is appreciated that the electronic circuit 14 included in the apparatus 10 is powered by an electrical source such as a battery 22 or a conditioned AC power source.

The microprocessor 16 of the electronic circuit 14 is preferably programmable such that the plurality of LEDs 18 may be driven to selectively illuminate in one of a variety of modes such as randomly, intermittently, continuously, with two or more LEDs 18 flashing simultaneously and most preferably in a blinking or flashing manner. The apparatus 10 includes an on/off switch 30 illustrated in FIG. 2 and preferably a mode selection switch 24 operative to allow a user to select one of the plurality of flashing modes as desired (see FIG. 3). Additionally, the apparatus may be adapted to include an intensity control switch whereby the level of illumination from the ornamental display can be adjusted.

The microprocessor 16 and LEDs 18 may be provided in a single housing 15 wherein the fiber optic bundles 20 are in communication with the LEDs 18 at a first end and extend outside the housing 15 to a second end that attaches to various illumination points distributed throughout the surface of the flexible planar member 12. It is appreciated that the discrete fiber optic bundles 20 may be arranged on the flexible planar member 12 to create one of a plurality of illuminated images. The fiber optic cables 20 may be arranged to display an illuminated a Christmas tree, flowers, images of characters or things, textual displays and the like.

The apparatus 10 of the present invention may be adapted to be a standalone unit that can thereafter be disposed on a favorite flexible planar member 12 as desired by the user, or alternatively the apparatus 10 may be predisposed onto the flexible planar member 12 as best illustrated in FIG. 2. In this manner, a user may select a favorite ornamental display or type of fiber optic illumination pattern from a predetermined number of patterns predisposed on the flexible planar member 12 by a manufacturer.

The apparatus 10 may be adapted to provide a user interface that allows the user to program the microprocessor to cause the LEDs 18 to illuminate in a favorite flashing pattern.

Illustratively, the plurality of LEDs 18 may be caused to light in a sequential manner wherein the fiber optic bundle associated with a particular LED will illuminate accordingly at the Christmas tree. In this manner the Christmas tree appears to illuminate in a sequence of various colors determined by the arrangement of the LEDs. It is appreciated that one or more LEDs may be caused to illuminate at any time which would result in the ornamental display appearing as either a single or multicolored as desired by the user.

Although the present invention was described herein as having utility for providing fiber optic illumination of Christmas trees and other ornamental displays, the invention also has utility as providing fiber optic illumination for other objects such as clothing, hats, toys, wall hangings, window shades or drapes and similar applications to provide an ornamental illuminates effect. The ornamental displays may be adapted to be disposed in various materials such as wood, metal, plastic, glass or other construction materials that can be used to provide a frame or support for the apparatus for providing a fiber optic display as according to the invention.

From the foregoing, an apparatus for fiber optic illumination of a material surface to provide an ornamental display is provided. Although a detailed description of the invention has been provided, it is appreciated that slight modifications of the above concept may become apparent to those skilled in the art that will not exceed the scope of the invention as described herein.

I claim:

1. An apparatus for the fiber optic illumination of an ornamental display, said apparatus comprising:
a flexible planar member;
a housing having a power source mounted to said flexible planar member;
a plurality of light emitting diodes disposed on said flexible planar member and in communication with said power source;
a plurality of fiber optic cable bundles, one of each of said plurality of light emitting diodes being in communication with one of each of said fiber optic bundles at a first end wherein a second end of each of said fiber optic bundles is attached to said flexible planar member to form an ornamental display; and
a programmable microprocessor disposed on said flexible planar member and in communication with said power source, said programmable microprocessor operative to selectively cause said light emitting diodes to be illuminated in one of a plurality of flashing modes.

2. The apparatus of claim 1 further comprising a mode selection switch operative to allow a user to select one of said plurality of flashing modes.

3. The apparatus of claim 2 wherein said plurality of flashing modes includes continuous, periodic, intermittent, and random modes.

4. The apparatus of claim 1 further comprising an intensity control switch.

5. The apparatus of claim 1 wherein said plurality of light emitting diodes is six.
